(19) United States
(12) Patent Application Publication
(10) Pub. No.: US 2004/0257686 A1
(43) Pub. Date: Dec. 23, 2004

(54) Mirror adjusting device especially for laser-processing machines

(76) Inventor: Johannes Meyer, Luneburg (DE)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/484,045

(22) PCT Filed: Jul. 17, 2001
(86) PCT No.: PCT/EP01/08240

(51) Int. Cl. G02B 7/182

(52) U.S. Cl. 359/872

(57) ABSTRACT

A mirror adjustment means, in particular for laser processing machines, with regard to a simple construction and an exact and quick adjustability of a mirror (16) to the desired position is improved according to the invention in that the mirror (16) is adjustably fastened on a fixed frame and that electrical linear motors (1, 2, 3) are arranged in an action-related manner between the frame (10) and the mirror (16), said motors acting on the mirror (16) via adjustment elements (18, 19).

The invention relates to a mirror-adjusting device, in particular for laser processing machines.

From U.S. Pat. No. 5,309,273 there is known a laser processing machine which uses two tiltable and rotating mirrors for guiding a laser beam onto a certain machining point of a work-piece. The arrangement of the three mirrors per se is already costly and requires further costly optical elements to the extent that the laser processing machine as a whole consists of four complicated parts which pushes up the costs for manufacture and maintenance.

Other known mirror-adjusting devices however use only one mirror, but this is then suspended in a complicated cardanic manner. At the same time the tilting device for the one tilt direction needs to be co-moved by the tilting device for the other tilt direction, which increases the masses to be moved and the complexity of the construction.

The mirrors of such laser processing machines are partly manufactured of copper and are designed water-cooled, which furthermore renders the arrangement heavier and more complicated. All mechanical elements need to be designed in a suitably stiff manner.

It is the object of the invention to specify a mirror-adjusting device which, with a simple construction, permits an exact and quick adjustment of a mirror onto the desired position.

The solution of this object according to the invention envisages that electrical linear motors are arranged in an action-related manner between the frame and the mirror, said motors acting on the mirror via adjustment elements. The device according to the invention makes do with a single mirror without the need for any complicated cardanic suspension. Indeed the linear movement of several, at least two linear motors may be transmitted directly onto the mirror. A linear motor is characterised by a very high adjustment [setting] force and an excellent precision on setting a predefined position. It thus provides excellent preconditions for the purpose of the present application. Intermediately arranged machine elements such as gears or other force transmission means may be largely done away with. At the same time the mechanical play of these machine elements is also automatically done away with, which contributes very much to the improvement of the precision.

In a preferred embodiment form it is envisaged that the frame comprises a triangular base shape and that three linear motors with their stators are arranged on the three sides of the frame in a manner such that the movement direction of their rotors runs essentially perpendicular to the plane of the frame triangle. By way of this measure, in contrast to the use of only two linear motors one may even do away with a one-sided mounting of the mirror in tilt joints. The mirror here is alone mounted on the rotors of the linear motors.

In an alternative formation of the invention it is envisaged that two linear motors are actively arranged between the mirror and the frame and a third linear motor is actively arranged between the machine chassis and the frame. The third linear motor in this manner may simultaneously assume two functions, specifically the displacement of the mirror-adjusting device relative to the machine chassis, and also the adjustment of the mirror by superposition in cooperation with the other linear motors. In this manner one may save one movement axis in many cases.

In one formation of the invention it is envisaged that the rotors of the linear motors are connected to the mirror via adjustment rods. This direct mechanical connection permits a play-free and thus very precise setting and adjustment with a simple constructional shape. Also, with a suitable design of the lengths of the adjustment rods, the basic adjustment of the mirror may be preadjusted over large angular ranges.

It is particularly useful if the adjustment rods are connected to the mirror by way of ball-and-socket joints. Then even with large adjustment paths no additional forces or bending moments are produced which may compromise the precision of the adjustment.

A mechanical restraint on the adjustment elements on tilting the mirror is advantageously avoided if the ball-and-socket joints are accommodated in longitudinal guides arranged in a star-shaped manner parallel to the mirror surface.

The mechanical effort may however be considerably reduced in that the adjustment rods are designed as elastically deformable adjustment plates. In this case one may specifically do away with the longitudinal guides. However the elastic deformation may lead to a systematic error in the deflection of the mirror which may not always be tolerated.

In such a case it is advantageous if one provides a control with a computing unit which is designed to compensate a systematic error due to a changing elastic bending of the adjustment plates in dependence on the deflection. The computing unit avoids the error for example in that the systematic error is summed with the computed nominal deflection. The systematic error may either be measured or computed at the beginning, or may be inputted to the control or its computation unit with the teach-in method in the manner known per se.

With a beam deflection for example of 90° it is advantageous if the mirror, preferably in a tiltable manner, is accommodated in a mounting, and if the adjustment rods are arranged on the mounting in an engaging manner. The mirror may then be set such that adjustment elements in the idle position all have the same deflection. The beam may then be deflected in every direction by the same magnitude of angle.

A further systematic error may be avoided in that the ball-and-socket joints have centres which define a triangular area whose centre is arranged in the mirror surface. If specifically the beam is directed to the centre of this triangular area then no displacement of the beam impingement point due to the mirror thickness is effected.

The impingement point of the beam advantageously remains stationary and the beam length advantageously changes slightly if the adjustment elements have changing deflections, whose sum is designed to add to zero.

The hysteresis error due to play in the joints may be avoided in a surprisingly simple manner by actively providing a spring between the mirror and the stator, whose force is designed to avoid play in the ball-and-socket joints. It is for example sufficient to tension a tension spring from the rear side of the mirror, preferably in the middle axis between the adjustment elements, to the frame. The tension produces a bias in the ball-and-socket joints which removes play from the joint.

In a further formation of the invention it is envisaged that the frame on its side distant to the mirror is provided with a base plate, and on its side facing the mirror is provided with a head plate, and that the head plate comprises openings for the passage of adjustment elements. The stability of the whole device is increased by this measure.

In a further formation of the invention it is suggested that there is provided machine chassis for fastening the laser and the frame to the mirror with respect to the work-piece to be machined. By way of this the position of the laser with respect to the mirror of the adjusting device, and the positions of the adjusting device and of the laser with respect to the work-piece may be fixed.

If an electrical linear motor for displacing the frame with respect to the machine chassis is arranged between the frame and the machine chassis in an action-related manner, then the frame may be additionally adjusted with respect to the laser.

If an optical lens is arranged in the beam path between the laser and the mirror, then the laser beam may be focussed onto the work-piece.

If furthermore an electrical linear motor for displacing the lens with respect to the machine chassis is arranged between the lens and the machine frame in an action-related manner then the focusing may be effected in a computer-controlled manner, or also only remotely. A continuous automatic refocusing may likewise be provided.

One embodiment example of the invention is explained hereinafter in more detail. The figures individually show in

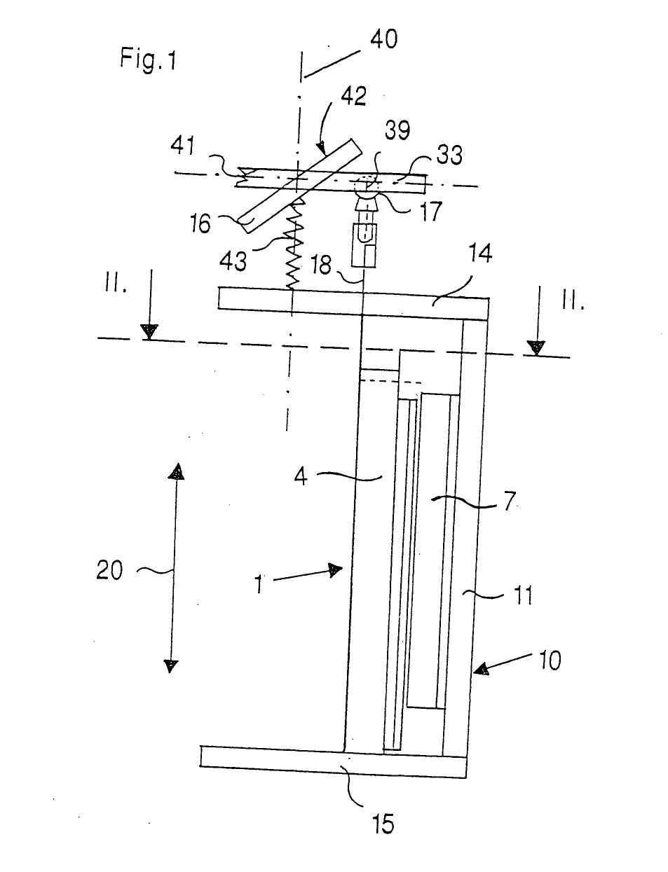

FIG. 1: a part view of a mirror-adjusting device according to the invention;

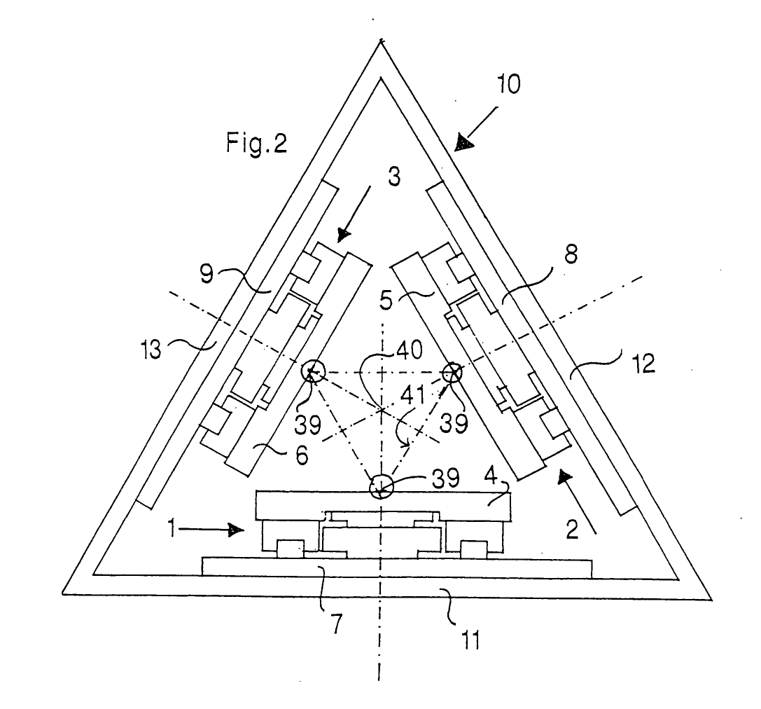

FIG. 2: a section according to line 11-11 of FIG. 1;

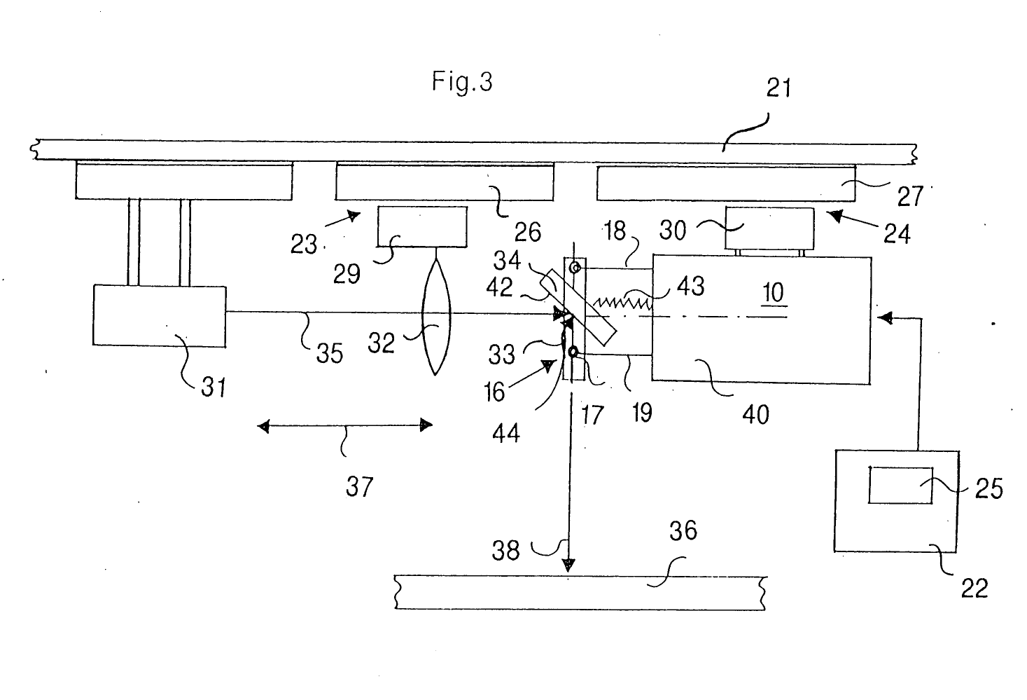

FIG. 3: a schematic representation of a laser processing machine.

In FIG. 1 one recognises an electrical linear motor 1 which consists essentially of a rotor 4 and a stator 7. The stator 7 is fastened on one frame side 11 of a frame 10 which at its one end is rigidly connected to a head plate 14 extending transversely to the frame side 11 and at its other end to a base plate 15 parallel to the head plates 14. A mirror 16 is fastened within a mounting 39 at a defined angle, of which only a part is shown in FIG. 1. The mounting 39 is connected via a ball-and-socket joint 17 to one end of the adjustment plate 18 which projects through an opening of the head plate 14 not indicated further, and at its other end is connected to the rotor 4 of the lineal motor 1. The movement direction of the linear motor 1 runs in the direction of the double arrow 20, thus parallel to the longitudinal direction of the adjustment plate 18.

As a whole three such linear motors are symmetrically distributed about a middle axis 40.

The ball-and-socket joint 17 has a centre 39 about which the mounting 33 pivots. The centres 39 of the in total three ball-and-socket joints 17 which are distributed symmetrically about the middle axis 40 thus form an equilateral triangular area 41. This area is intersected by the mirror surface 42 such that the middle axis 40 penetrates the intersection line of the mirror surface 42 with the triangular area 41.

A tension spring 43 which is tensioned between the mirror or mounting 33 to the head plate 14 alleviates any play of the ball-and-socket joints 17 which may be present.

In FIG. 2 one recognises in section the construction of the adjusting device which consists of three lineal motors 1, 2, 3 whose three stators 7, 8, 9 are fastened on three frame sides 11, 12, 13 of the frame 10. The flame 10 thus has essentially the shape of an isosceles triangle. The three rotors 4, 5,6 are connected via three adjustment plates 18, 19 which are not shown in FIG. 2, to the mirror 16 which likewise is not shown. The movement direction of the linear motors 1, 2, 3 in the representation of FIG. 2 are perpendicular to the plane of the drawing.

In FIG. 3 one recognises a part of a machine chassis 21 on which two further linear motors 23 and 24 are fastened with their respective stators 26 and 27. The laser 31 is directly connected to the machine chassis 21. The rotor 29 of the linear motor 23 is connected to a lens 32. The rotor 30 of the second linear motor 24 is connected to the flame 10 of the adjustment device.

The computer unit 25 in the control 22, by way of superposition of the movements, also permits the desired movement of the mirror 16 to be produced merely by cooperation of two linear motors between the frame 10 and the mirror 16, and of a linear motor 24 between the frame 10 and the machine chassis 21. With this the linear motors 2 and 3 tilt the mirror 16 about a vertical axis whilst linear motor 24 in cooperation with the other two motors 2 and 3 may tilt the mirror 16 about a horizontal axis without at the same tine the reflection point 44 being displaced. The third point of articulation of the mirror 16 at the same time is fixed relative to the frame but however is displaced relative to the machine chassis 21 by the linear motor 24.

The mirror 16 consists of a mounting 33 and a mirror plate 34 which is pivotally fastened on the mounting 33. The mounting 33 is connected via three ball-and-socket joints 17 to three adjustment plates 18, 19 of which only two may be recognised in FIG. 3. The mirror plate 34 consists of pure copper whose mirror surface 42 has been surface-mirrored.

A laser beam 35 leaves the laser 31 and runs firstly horizontally and coaxially to the middle axis 40 of the adjusting device, wherein it passes through the lens 32 and impinges the mirror 16. The mirror surface 42 of the mirror 16 reflects the laser beam vertically downwards onto a work-piece 36. The point of reflection lies in the triangular area 41 formed by the centres of the ball-and-socket joints 17. A control 22 with a computer unit 25 controls the linear motors 1, 2 and 3 such that the deflections of the ball-and-socket joints summed add up to zero. In this manner the point of reflection 44 remains fixed in space.

On adjusting the mounting 33 the distance of the centres 39 to the middle axis 40 changes only slightly. A systematic error of the adjustment angle which arises on account of this is compensated by the computer unit 25.

The laser beam 35 may be focussed onto the work-piece 36 by traversing the lens 32 by way of a linear motor 23 in the direction of the double arrow 37.

The position of the focal point 38 on the work-piece may be positioned by traversing the frame 10 by way of the second linear motor 24.

By adjusting the mirror 16 by way of the three linear motors 1, 2, 3 of the adjusting device the local point 38 may be set and finely adjusted quickly and precisely onto any number of predefined locations of the work-piece 36. At the same time the focal point may be displaced in a direction lying perpendicular to the plane of the drawing in FIG. 3 by way of displacements of the three linear motors 1, 2, 3 which are matched to one another.

List of Reference Numerals

1 linear motor

2 linear motor

3 linear motor

4 rotor

5 rotor

6 rotor

7 stator

8 stator

9 stator

10 frame

11 frame side

12 frame side

13 frame side

14 head plate

15 base plate

16 mirror

17 ball-and-socket joint

18 adjustment plate

19 adjustment plate

20 double arrow

21 machine chassis

22 control

23 linear motor

24 linear motor

24 control unit

25 computation unit

26 stator

27 stator

28 stator

29 rotor

30 rotor

31 laser

32 lens

33 holder

34 mirror plate

35 laser beam

36 work-piece

37 double arrow

38 focal point

39 centre

40 middle axis

41 triangular plane

42 mirror surface

43 spring

44 point of reflection

1. A mirror-adjusting device, in particular for laser processing machines, characterised in that the mirror (16) is adjustably fastened on a fixed frame (10) and that electrical linear motors (1, 2, 3) are arranged in an action-related manner between the frame (10) and the mirror (16), said motors acting on the mirror (16) via adjustment elements (18, 19).

2. A mirror-adjusting device according to claim 1, characterised in that the frame (10) has a triangular base shape and that thee linear motors (I, 2, 3) with their stators (7, 8, 9) are arranged on the three frame sides (11, 12, 13) in a manner such that the movement direction (20, 37) of their rotors (4, 5, 6) runs essentially perpendicular to the plane of the frame triangle.

3. A mirror-adjusting device according to claim 1, characterised in that two linear motors (2,3) are actively arranged between the mirror (16) and the frame (10), and a third linear motor (24) between the machine chassis (21) and the frame (10).

4. A mirror-adjusting device according to claim 1, 2 or 3, characterised in that the rotors (4, 5, 6) of the linear motors (1, 2, 3) are connected to the mirror (16) via adjustment rods (18, 19).

5. A mirror-adjusting device according to one of the preceding claims, characterised in that the adjustment rods (18, 19) are connected to the mirror (16) by way of ball-and-socket joints (17).

6. A mirror-adjusting device according to claim 5, characterised in that the ball-and-socket joints are accommodated in longitudinal guides arranged star-shaped parallel to the surface of the mirror.

7. A mirror-adjusting device according to claim 4, 5 or 6, characterised in that the adjustment rods are designed as elastically deformable adjustment plates (18, 19).

8. A mirror-adjusting device according to one of the preceding claims, characterised in that there is provided a control (22) with a computer unit (25) which is designed to compensate a systematic error due to changing elastic bending of the adjustment plates (18, 19) in dependence on the deflection.

9. A mirror-adjusting device according to one of the preceding claims, characterised in that the mirror (16), preferably tiltable, is accommodated in a mounting (33) and the adjustment rods are arranged engaging on the mounting (33).

10. A mirror-adjusting device according to one of the preceding claims, characterised in that the ball-and-socket joints (17) have centres (39) which define a triangular area (41) whose middle is arranged in the mirror surface (42).

11. A mirror-adjusting device according to one of the preceding claims, characterised in that the adjustment elements have changing deflections whose sum is designed to add up zero.

12. A mirror-adjusting device according to one of the preceding claims, characterised in that a spring is actively provided between the mirror (16) and the frame (19), whose force is designed to avoid a play in the ball-and-socket joints (I 7).

13. A mirror-adjusting device according to one of the preceding claims, characterised in that the frame (10) on its side distant to the mirror (16) is provided with a base plate (15) and on its side facing the mirror (16) is provided with a head plate (14), and that the head plate (14) comprises openings for the passage of adjustment elements (18, 19).

14. A mirror-adjusting device according to one of the preceding claims, characterised in that a machine chassis (21) is provided for fastening the laser (31) and the frame (10) to the mirror (16) with respect to a work-piece (36) to be machined.

15. A mirror-adjusting device according to one of the preceding, claims, characterised in that an electrical linear motor (24) for displacing the frame (10) with respect to the machine chassis (21) is arranged in an action-related manner between the frame (10) and the machine chassis (21).

16 A mirror-adjusting device according to one of the preceding claims, characterised in that an optical lens (32) is arranged in the beam path between the laser (31) and the mirror (16).

17. A mirror-adjusting device according to one of the preceding claims, characterised in that an electrical linear motor (23) for displacing the lens (32) with respect to the machine chassis (21) is arranged in an action related manner between the lens (32) and the machine chassis (21).
